(19) United States
(12) Patent Application Publication
(10) Pub. No.: US 2025/0171231 A1
(43) Pub. Date: May 29, 2025

(54) A REMOTELY OPERATED VEHICLE, AN AUTOMATED STORAGE AND RETRIEVAL SYSTEM AND A METHOD OF DRIVING A REMOTELY OPERATED VEHICLE FOR HANDLING A GOODS HOLDER OF AN AUTOMATED STORAGE AND RETRIEVAL SYSTEM

(71) Applicant: AutoStore Technology AS, Nedre Vats (NO)

(72) Inventors: Trond Austrheim, Etne (NO); Ivar Fjeldheim, Haugesund (NO)

(21) Appl. No.: 18/842,512

(22) PCT Filed: Feb. 17, 2023
(86) PCT No.: PCT/EP2023/054060

§ 371 Date: Aug. 29, 2024

(30) Foreign Application Priority Data
Mar. 8, 2022 (NO) 20220290

(51) Int. Cl. B65G 1/06; B65G 1/04

(52) U.S. Cl. CPC B65G 1/065; B65G 1/0464

(57) ABSTRACT

The invention relates to a remotely operated vehicle for handling a goods holder while operating on a two-dimensional rail system of an automated storage and retrieval system. The vehicle comprises a vehicle body and a first set of wheels enabling movement of the remotely operated vehicle in a first horizontal direction of the rail system and a second set of wheels enabling movement of the remotely operated vehicle in a second horizontal direction of the rail system. The second direction is perpendicular to the first direction. The vehicle body comprises a motor section that houses at least one drive motor and a cavity section that provides a cavity for storing a goods holder. The vehicle has a center of gravity (COG) located in the cavity section wherein the first set of wheels comprises a pair of driven wheels and a pair of passive wheels.

The present invention relates primarily to a remotely operated vehicle for handling a goods holder of an automated storage and retrieval system.

### BACKGROUND AND PRIOR ART

FIG. 1 discloses a prior art automated storage and retrieval system 1 with a framework structure 100 and FIGS. 2, 3a-3b disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form container stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 301, 401 in a first direction X across the top of the frame structure 100, and a second set of parallel rails 111 arranged perpendicular to the first set of rails 110 to guide movement of the container handling vehicles 301, 401 in a second direction Y which is perpendicular to the first direction X. Containers 106 stored in the columns 105 are accessed by the container handling vehicles 301, 401 through access openings 112 in the rail system 108. The container handling vehicles 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 201c, 301b, 301c, 401b, 401c which enable lateral movement of the container handling vehicles 201, 301, 401 in the X direction and in the Y direction, respectively. In FIGS. 2-3b, two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lifting device 304, 404 (visible in FIGS. 3a-3b) having a lifting frame part 304a for vertical transportation of storage containers 106, e.g. raising a storage container 106 from, and lowering a storage container 106 into, a storage column 105. Lifting bands 404a are also shown in FIG. 3b. The lifting device 304, 404 comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z (visible for instance in FIG. 1) which is orthogonal the first direction X and the second direction Y. Parts of the gripping device of the container handling vehicles 301, 401 are shown in FIGS. 3a and 3b indicated with reference numbers 304 and 404. The gripping device of the container handling device 201 is located within the vehicle body 201a in FIG. 2.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=18, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells within storage columns. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 3b and as described in e.g. WO2015/193278A1 and WO2019/206487A1, the contents of which are incorporated herein by reference. FIG. 3a shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIG. 3b and as disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks; in other rail systems 108, each rail in one direction may comprise one track and each rail in the other perpendicular direction may comprise two tracks. The rail system may also comprise a double track rail in one of the X or Y direction and a single track rail in the other of the X or Y direction. A double track rail may comprise two rail members, each with a track, which are fastened together.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or a dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are, once accessed, returned into the framework structure 100. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different heights, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301, 401 lifting device (not shown in FIG. 2 but visible in FIGS. 3a and 3b), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106 and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 (shown in FIG. 1) which typically is computerized and which typically comprises a database for keeping track of the storage containers 106.

With reference to FIGS. 2-3b, the choice of type of the container handling vehicle may frequently be a compromise between different parameters and considerations, such as for example, vehicle capacity, its cost of purchase and/or reliability as well as the vehicle's intended tasks. By way of example, vehicles of a cantilever type, shown in FIG. 3a, have proven over the years to be very reliable in operation and are comparatively cheap to install, whereas vehicles having an internally arranged cavity, shown for instance in FIG. 3b, offer benefits in terms of space-efficiency and ability to operate at higher speeds but tend to be more expensive than their cantilever counterparts.

Further container handling vehicles are disclosed in WO2021/175953A1 and WO2017/152210A1.

With reference to all of above-mentioned vehicles, it is desirable to provide new container handling vehicles which offer further benefits to a storage system owner.

### SUMMARY OF THE INVENTION

The present invention is set forth and characterized in the independent claims, while the dependent claims describe other characteristics of the invention.

The invention relates to a remotely operated vehicle for handling a goods holder while operating on a two-dimensional rail system of an automated storage and retrieval system, wherein said vehicle comprises a vehicle body and a first set of wheels enabling movement of the remotely operated vehicle in a first horizontal direction of the rail system and a second set of wheels enabling movement of the remotely operated vehicle in a second horizontal direction of the rail system, said second direction being perpendicular to the first direction, wherein the vehicle body comprises a motor section that houses at least one drive motor and a cavity section that provides a cavity for storing a goods holder, the remotely operated vehicle having a center of gravity located in the cavity section wherein the first set of wheels comprises a pair of driven wheels and a pair of passive wheels, wherein at least the passive wheels face one another, the pair of passive wheels being provided in the cavity section to transfer a share of a load from the remotely operated vehicle to the rail system when moving in the first horizontal direction, the pair of passive wheels being arranged on an opposite side of the center of gravity to the pair of driven wheels of the first set of wheels.

By providing the remotely operated vehicle as defined above, i.e. having a pair of non-driven wheels, a simplified, more robust vehicle design is achieved. This also entails less complex maintenance procedure.

In a related context, by providing a dedicated motor section that houses at least one drive motor and by providing passive wheels result in significant weight reduction of the vehicle. This is particularly true in the embodiments where wheels in the cavity section are passive wheels and wheels of the motor section are driven wheels as in this configuration additional drive motors as well as motion transmission mechanisms become redundant.

As discussed above, total weight of the vehicle may be reduced. This, in turn, results in vehicle having better acceleration properties. In a related context, total kinetic energy of a moving vehicle is significantly reduced. Accordingly, accidental collisions occurring on the rail system, involving further vehicles and/or human operators, would have less serious consequences.

Moreover, the presence of non-driven wheels reduces the risk of front wheels starting to spin as a consequence of traction loss between the wheel and the supporting rail.

Second aspect of the invention relates to a method of driving a remotely operated vehicle for handling a goods holder on a two-dimensional rail system of an automated storage and retrieval system in accordance with claim 16.

For the sake of brevity, advantages discussed above in connection with the remotely operated vehicle may even be associated with the corresponding method and are not further discussed. Here, it is to be construed that the sequence of method steps of claim 16 may be effectuated in any given order.

For the purposes of this application, the term “container handling vehicle” used in “Background and Prior Art”-section of the application and the term “remotely operated vehicle” used in “Detailed Description of the Invention”-section both define a robotic wheeled vehicle operating on a rail system arranged across the top of the framework structure being part of an automated storage and retrieval system. Analogously, the term “storage container” used in “Background and Prior Art”-section of the application and the term “goods holder” used in “Detailed Description of the Invention”-section both define a receptacle for storing items. In this context, the goods holder can be a bin, a tote, a pallet, a tray or similar. Different types of goods holders may be used in the same automated storage and retrieval system. The relative terms “upper”, “lower”, “below”, “above”, “higher” etc. shall be understood in their normal sense and as seen in a Cartesian coordinate system.

When mentioned in relation to a rail system, “upper” or “above” shall be understood as a position closer to the surface rail system (relative to another component), contrary to the terms “lower” or “below” which shall be understood as a position further away from the rail system (relative another component).

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle/remotely operated vehicle having a centrally arranged cavity for carrying storage containers therein.

FIG. 3a is a perspective view of a prior art container handling vehicle/remotely operated vehicle having a cantilever for carrying storage containers underneath.

FIG. 3b is a perspective view, seen from below, of a prior art container handling vehicle/remotely operated vehicle having an internally arranged cavity for carrying storage containers therein.

FIG. 4 is a schematic top view of a grid structure where roof-supporting columns are marked.

FIG. 5 is a side view of a remotely operated vehicle in accordance with one embodiment of the present invention.

FIG. 6 is a side view of a remotely operated vehicle in accordance with another embodiment of the present invention.

FIG. 7 contextualizes the invention by showing two different scenarios where a remotely operated vehicle in accordance with an embodiment of the present invention is positioned on the rails of the framework structure.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

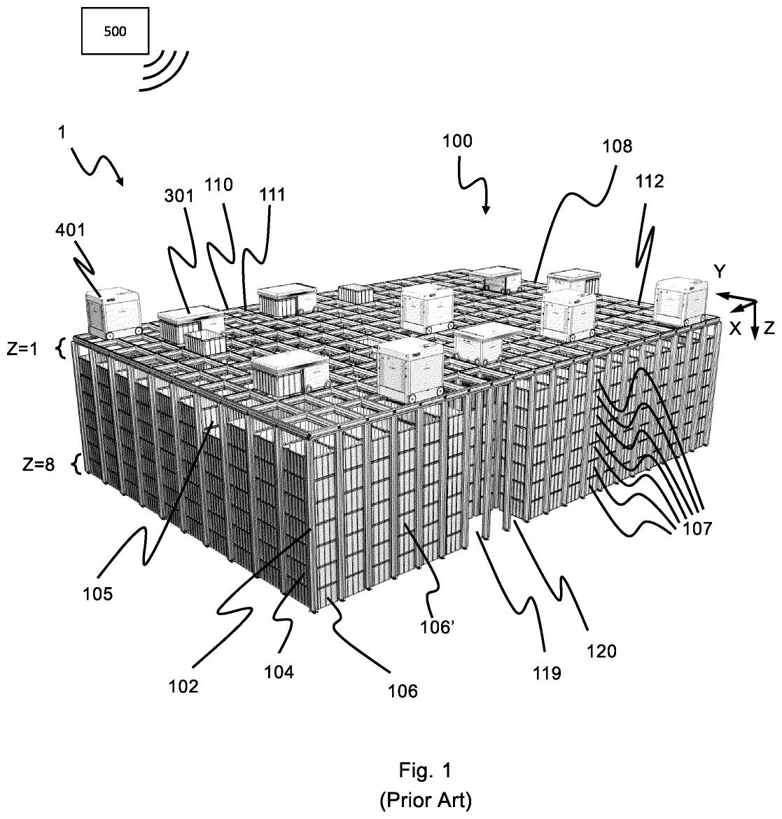

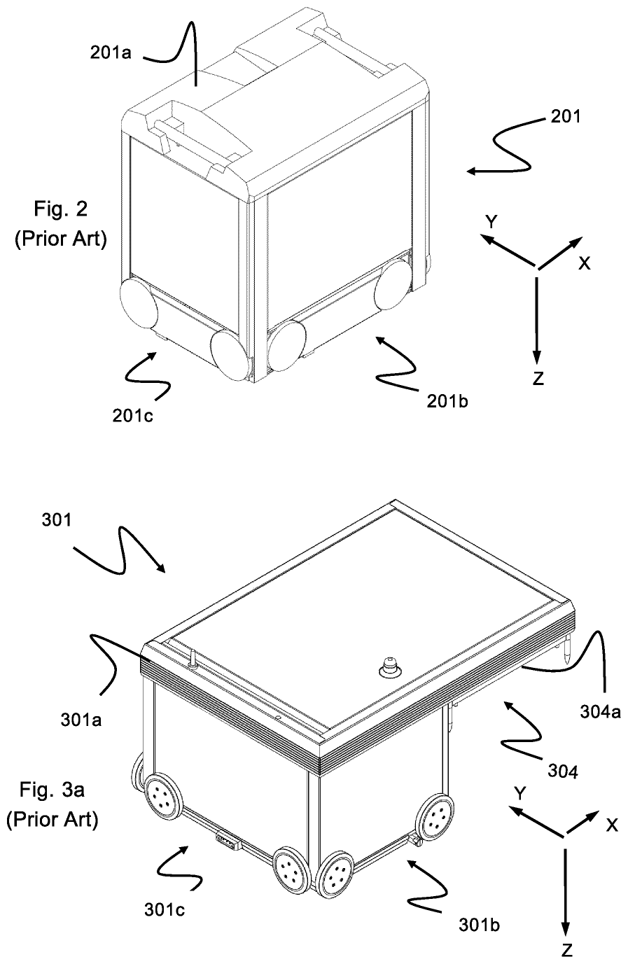

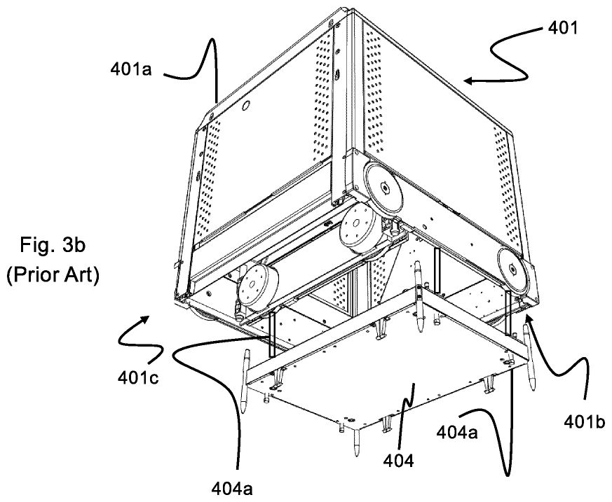

The framework structure 100 of the automated storage and retrieval system 1 is constructed in accordance with the prior art framework structure 100 described above in connection with FIGS. 1-3b, i.e. a number of upright members 102, wherein the framework structure 100 also comprises a first, upper rail system 108 in the X direction and Y direction.

The framework structure 100 further comprises storage compartments in the form of storage columns 105 provided between the members 102 where storage containers 106 are stackable in stacks 107 within the storage columns 105.

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers.

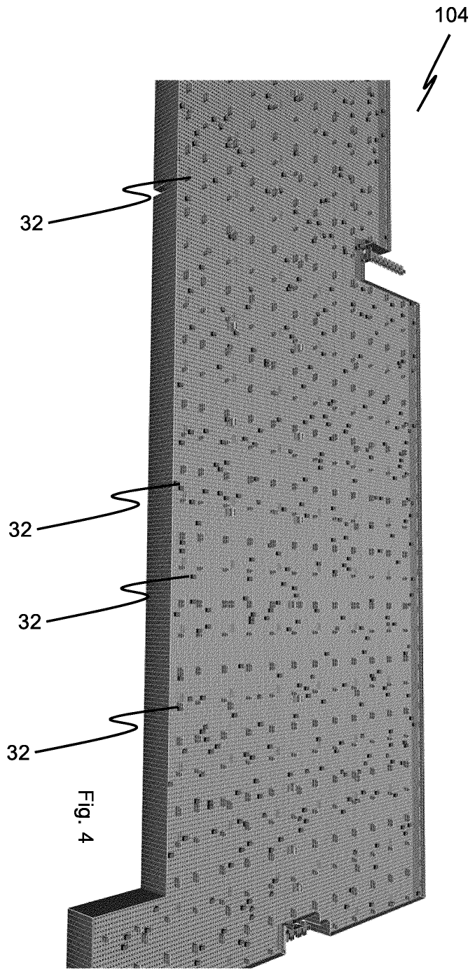

Various aspects of the present invention will now be discussed in more detail with reference to FIGS. 4-7.

FIG. 4 is a schematic top view of a grid structure 104 of the type shown in FIG. 1 where roof-supporting columns 32 are marked. Shown grid structure 104 is representative for real-life situations where an automated storage and retrieval system for goods holders needs to be fitted into an existing facility comprising a number of such roof-supporting columns 32. To achieve a space-efficient automated storage and retrieval system, it is desirable to put to use the space immediately adjacent the roof-supporting columns 32 as well as the space next to outer boundaries of the system, i.e. to extend the storage volume all the way to the roof-supporting columns/outer physical boundaries of the storage system.

In the following, a remotely operated vehicle suitable for efficiently operating on the grid structure of FIG. 4 will be discussed in greater detail.

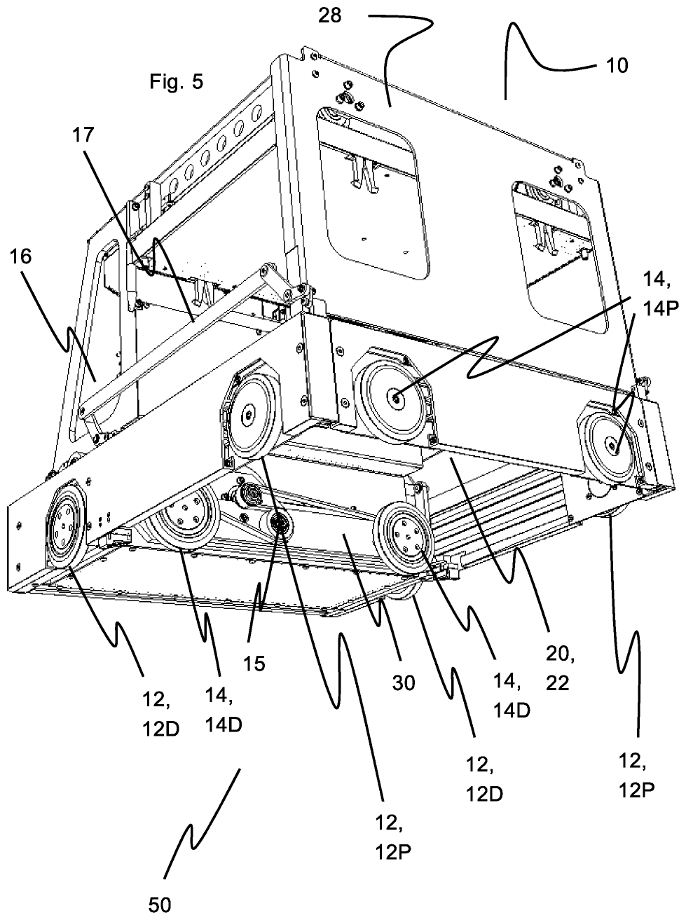

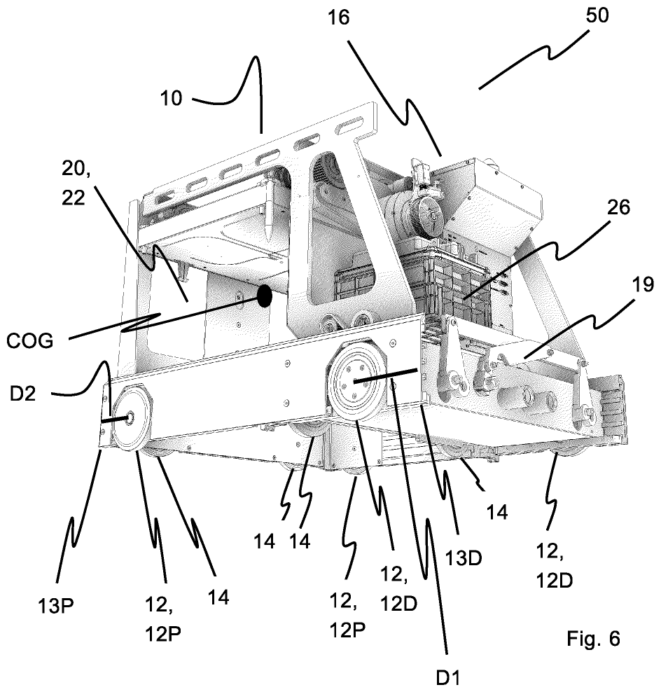

A remotely operated vehicle 50 of FIG. 5 is for handling goods holders while operating on a two-dimensional rail system of an automated storage and retrieval system shown in FIG. 1. The vehicle 50 comprises a vehicle body 10 and a first set of wheels 12 enabling movement of the remotely operated vehicle 50 in a first horizontal direction (for instance X-direction) of the rail system and a second set of wheels 14 enabling movement of the remotely operated vehicle 50 in a second horizontal direction (for instance Y-direction) of the rail system. With reference to FIG. 1, the second (Y) direction is perpendicular to the first (X) direction. The vehicle body 10 comprises a motor section 16 that houses at least one drive motor and a cavity section 20 that provides a cavity 22 for storing a goods holder. As shown in FIG. 6, a center of gravity COG (not visible in FIG. 5) of the remotely operated vehicle 50 is located in the cavity section 20.

Turning back to FIG. 5, the first set of wheels 12 comprises a pair of driven wheels 12D and a pair of passive wheels 12P. In the shown embodiment, the wheels of the pair of passive wheels 12P face one another, said passive wheels 12P being provided in the cavity section 20. The passive wheels 12P transfer a share of a load from the remotely operated vehicle 50 to the rail system when said vehicle 50 is moving in the first horizontal direction. With reference to FIGS. 5-6, the pair of passive wheels 12D is arranged on an opposite side of the center of gravity COG to the pair of driven wheels 12P.

By providing the remotely operated vehicle 50 with a pair of passive (non-driven) wheels 12P, a simplified, more robust vehicle design is achieved. This also entails less complex maintenance procedure.

Vehicle design in accordance with FIG. 5 also contributes to significant weight reduction of the vehicle 50 as additional drive motors as well as motion transmission mechanisms become redundant in this configuration. In addition, reduced total weight of the vehicle 50 results in the vehicle having better acceleration properties. In a related context, total kinetic energy of the moving vehicle 50 is significantly reduced. Accordingly, accidental collisions occurring on the rail system shown in FIG. 1, involving further vehicles and/or human operators, would have less serious consequences.

Still with reference to FIG. 5, the cavity section 20 includes an external wall 28 forming part of the periphery of the remotely operated vehicle 50. The external wall 28 is flat and perpendicular to a horizontal (XY) plane of FIG. 1.

As regards a second set of wheels 14, said second set of wheels 14 comprises one pair of wheels mounted to a structural crosspiece 30 within the vehicle body 10. In FIG. 5, this pair of wheels is a pair of driven wheels 14D. A motor 15 for driving said driven wheels 14D of the second set of wheels 14 is also shown in FIG. 5. Arranged opposite said pair of driven wheels 14D is a pair of passive wheels 14P of the second set of wheels 14. As shown in FIG. 5, said pair of passive wheels 14P is arranged in the external wall 28 of the remotely operated vehicle 50. A motor (not shown) for lifting/lowering second set of wheels 14 is provided in the motor section 16 of the vehicle 50. In the art, lifting and lowering of the set of wheels, in order to change direction of movement of the container handling vehicle from X-direction to Y-direction of FIG. 1, or vice versa, is known as “trackshift”. Parts of a trackshift mechanism 17 are also shown.

FIG. 6 is a side view of a remotely operated vehicle 50 in accordance with another embodiment of the present invention. More precisely, a different trackshift mechanism is employed in the embodiment of FIG. 6. Parts of that trackshift mechanism 19 are shown in FIG. 6.

As easily inferred, a footprint of the shown remotely operated vehicle 50 is rectangular, whereas the vehicle body 10 has an asymmetric shape in a plane extending in YZ-direction (indicated in FIG. 1).

Turning back to a first set of wheels 12 (discussed in conjunction with FIG. 5), a pair of driven wheels 12D of said first set of wheels 12 is provided in a motor section 16 of the remotely operated vehicle 50. Moreover, a wheel axle (not visible in FIGS. 5-6) associated with the pair of driven wheels 12D of the first set of wheels 12 is provided in the motor section 16 of the remotely operated vehicle 50. A drive motor (obscured by a triangle-shaped structural piece of FIG. 6) for powering the driven wheels 12D is provided in said motor section 16 that also holds a battery 26 of the remotely operated vehicle 50. The motor section 16 and a cavity section 20 are arranged side-by-side. The pair of passive wheels 12P is arranged on an opposite side of the center of gravity COG to the pair of driven wheels 12D. The passive wheels 12P of the first set of wheels 12 are not connected by means of a wheel axle and turn independently of one another. In this way, individual wheels are isolated and a possible wheel spin is contained to a single wheel of a wheel pair. A second set of wheels 14 (discussed in conjunction with FIG. 5) is also shown.

On a general level, the presence of non-driven wheels reduces the risk of these wheels starting to spin as a consequence of traction loss between the wheel and the supporting rail.

Still with reference to FIG. 6, a distance D1 between a center of one of the driven wheels 12D of the first set of wheels 12 and a thereto associated corner 13D of the vehicle 50 is larger than a distance D2 between a center of one of the passive wheels 12P of the first set of wheels 12 and a thereto associated corner 13P of the vehicle 50. In one embodiment, two driven wheels 12D of the first set of wheels are equisized and two passive wheels 12P of the first set of wheels are equisized. The two driven wheels 12P have larger diameter than the two passive wheels 12P.

Providing smaller passive wheels 12P and larger driven wheels 12D entails that the passive wheels 12P may be moved closer to the corner of the vehicle 13P, i.e. closer to the peripheral edge of the vehicle. In this way, more weight is supported by the driven wheels. The result is a better overall weight distribution in the vehicle and a more stable vehicle having passive wheels less prone to spinning.

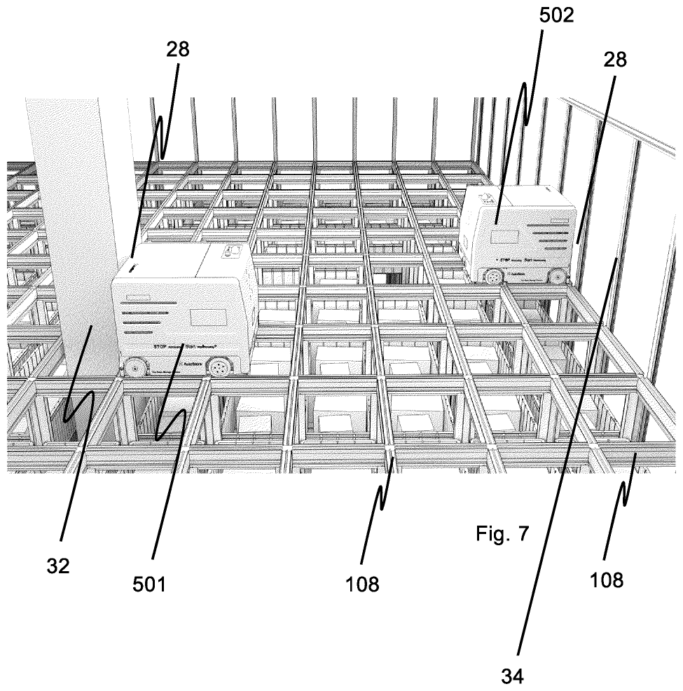

FIG. 7 contextualizes the present invention by showing two different scenarios where remotely operated vehicles are positioned on the rails 108 of the framework structure.

With reference to FIG. 4, a first one of the remotely operated vehicles 501 shown in FIG. 7 is positioned above a storage column being immediately adjacent a roof supporting column 32. By virtue of its design, the vehicle 501 is able to access goods holders stored in said storage column. More specifically, the cavity section (shown and discussed in conjunction with FIGS. 5-6) of the vehicle 501 includes a peripheral external wall 28 facing the roof supporting column 32. The external wall 28 is flat and perpendicular to a horizontal (XY) plane. When the flat, external wall 28 of the vehicle 501 is very close to or even abutting the roof supporting column 32, the cavity section is aligned with the storage column below such that the goods holder may be vertically extracted by the remotely operated vehicle 501.

The other one of the remotely operated vehicles 502 shown in FIG. 7 is shown positioned at the periphery of grid structure of FIG. 4, adjacent to a protective fence 34 delimiting the grid structure. Analogously to what has been discussed in connection with the first remotely operated vehicle 501 of FIG. 7, the external wall 28 of the vehicle 502 being flat and perpendicular to a horizontal (XY) plane entails above-discussed benefits, such as improved capability to retrieve goods holders that are difficult to access.

A common feature of the two scenarios of FIG. 7 is the remotely operated vehicle 501, 502, when lifting goods holders from a storage column or lowering goods holders into the storage column, covers a single storage column across in one horizontal direction of the rail system 108 and covers between one and two storage columns across in another horizontal direction of the rail system 108. For a given grid size, this relatively small vehicle footprint opens for usage of larger number of remotely operated vehicles than what was previously feasible. More specifically, in one of the horizontal directions it is possible for two operating vehicles 501, 502 to occupy adjacent grid positions so that the flat, external wall 28 of one vehicle 501, 502 faces the flat, external wall 28 of another vehicle 501, 502.

In an embodiment (not shown), the remotely operated vehicle might comprise a track sensor and an encoder associated to at least one of the passive wheels. The encoder enables conversion of the rotational motion of the thereto associated passive wheel to an analog or digital code. The track sensor receives signals generated by the encoder. It is thereby provided an accurate and reliable means for determining the vehicle's travelled distance.

In the preceding description, various aspects of the levelling assembly for a storage and retrieval system for storing goods holders according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Storage and retrieval system
10 Vehicle body
12 First set of wheels
12D Driven wheels of first set
12P Passive wheels of first set
13D Vehicle corner associated with driven wheels
13P Vehicle corner associated with passive wheels
14 Second set of wheels
14D Driven wheels of the second set of wheels
14P Passive wheels of the second set of wheels
15 Motor for driving second set of wheels
16 Motor section
17 Parts of first trackshift mechanism
19 Parts of first trackshift mechanism
20 Cavity section
22 Cavity
26 Battery
28 External wall
30 Crosspiece
32 Roof-supporting column
34 Protective fence
50 Remotely operated vehicle
COG Center of Gravity
D1 Distance driven wheel-to-corner
D2 Distance passive wheel-to-corner
100 Framework structure
102 Upright members of framework structure
104 Storage grid
105 Storage column
106 Storage container/goods holder
106′ Particular position of storage container
107 Stack of storage containers
108 Rail system
110 Parallel rails in first direction (X)
111 Parallel rails in second direction (Y)
112 Access opening
119 First port column
201 Container handling vehicle belonging to prior art
201a Vehicle body of the container handling vehicle 201
201b Drive means/wheel arrangement, first direction (X)
201c Drive means/wheel arrangement, second direction (Y)
301 Cantilever-based container handling vehicle belonging to prior art
301a Vehicle body of the container handling vehicle 301
301b Drive means in first direction (X)
301c Drive means in second direction (Y)
401 Container handling vehicle belonging to prior art
401a Vehicle body of the container handling vehicle 401
401b Drive means in first direction (X)
401c Drive means in second direction (Y)
501 Remotely operated vehicle
502 Remotely operated vehicle
X First direction
Y Second direction
Z Third direction
201a Vehicle body of the container handling vehicle 201
201b Drive means/wheel arrangement, first direction (X)
201c Drive means/wheel arrangement, second direction (Y)
301 Cantilever-based container handling vehicle belonging to prior art
301a Vehicle body of the container handling vehicle 301
301b Drive means in first direction (X)
301c Drive means in second direction (Y)
401 Container handling vehicle belonging to prior art
401a Vehicle body of the container handling vehicle 401
401b Drive means in first direction (X)
401c Drive means in second direction (Y)
501 Remotely operated vehicle
502 Remotely operated vehicle
X First direction
Y Second direction
Z Third direction

1-18. (canceled)

19. A remotely operated vehicle for handling a goods holder while operating on a two-dimensional rail system of an automated storage and retrieval system, wherein said vehicle comprises a vehicle body and a first set of wheels enabling movement of the remotely operated vehicle in a first horizontal direction of the rail system and a second set of wheels enabling movement of the remotely operated vehicle in a second horizontal direction of the rail system, said second horizontal direction being perpendicular to the first horizontal direction, wherein the vehicle body comprises a motor section that houses at least one drive motor and a cavity section that provides a cavity for storing a goods holder, the remotely operated vehicle having a center of gravity (COG) located in the cavity section wherein the first set of wheels comprises a pair of driven wheels and a pair of passive wheels, wherein at least the passive wheels face one another, the pair of passive wheels being provided in the cavity section to transfer a share of a load from the remotely operated vehicle to the rail system when moving in the first horizontal direction, the pair of passive wheels being arranged on an opposite side of the center of gravity (COG) to the pair of driven wheels of the first set of wheels.

20. The remotely operated vehicle of claim 19, wherein the pair of driven wheels of the first set of wheels is provided in the motor section of the remotely operated vehicle.

21. The remotely operated vehicle of claim 19, wherein a wheel axle associated with the pair of driven wheels of the first set of wheels is provided in the motor section of the remotely operated vehicle.

22. The remotely operated vehicle of claim 19, wherein the passive wheels turn independently of one another.

23. The remotely operated vehicle of claim 19, wherein a footprint of the remotely operated vehicle is rectangular.

24. The remotely operated vehicle of claim 19, wherein the remotely operated vehicle, when lifting goods holders from a storage column or lowering goods holders into the storage column, covers a single storage column across in one horizontal direction of the rail system and covers between one and two storage columns across in another horizontal direction of the rail system.

25. The remotely operated vehicle of claim 19, wherein for the first set of wheels, a distance between one of the driven wheels and a thereto associated corner of the vehicle is larger than a distance between one of the passive wheels and a thereto associated corner of the vehicle.

26. The remotely operated vehicle of claim 19, wherein for the first set of wheels, the driven wheels are equisized and the passive wheels are equisized and the driven wheels have larger diameter than the passive wheels.

27. The remotely operated vehicle of claim 19, wherein the vehicle body has an asymmetric shape in a plane extending in YZ-direction.

28. The remotely operated vehicle of claim 19, wherein a battery of the remotely operated vehicle is provided in a motor section of the remotely operated vehicle, said motor section and the cavity section being arranged side-by-side.

29. The remotely operated vehicle of claim 19, wherein the cavity section includes an external wall forming part of a periphery of the remotely operated vehicle, said wall being flat and perpendicular to a horizontal plane.

30. The remotely operated vehicle of claim 19, wherein the second set of wheels comprises one pair of wheels mounted to a structural crosspiece within the vehicle body.

31. The remotely operated vehicle of claim 19, wherein the second set of wheels comprises a pair of passive wheels.

32. The remotely operated vehicle of claim 31, wherein said pair of passive wheels is arranged in an external wall of the remotely operated vehicle.

33. An automated storage and retrieval system, comprising:
a remotely operated vehicle as recited in claim 19;
a plurality of storage columns and a rail system provided above the plurality of storage columns;
wherein a goods holder may be lowered into or lifted from any of the storage columns by the remotely operated vehicle operating on the rail system.

34. A method of driving a remotely operated vehicle for handling a goods holder on a two-dimensional rail system of an automated storage and retrieval system, wherein said vehicle comprises a vehicle body and a first set of wheels enabling movement of the remotely operated vehicle in a first horizontal direction of the rail system and a second set of wheels enabling movement of the remotely operated vehicle in a second horizontal direction of the rail system, wherein at least passive wheels, among the first set of wheels and the second wheels, face one another, said second direction being perpendicular to the first direction, wherein the vehicle body comprises a motor section that houses at least one drive motor and a cavity section that provides a cavity for storing a goods holder, the remotely operated vehicle having a center of gravity (COG) located in the cavity section said method comprising:
driving the remotely operated vehicle in the first horizontal direction by driving a pair of driven wheels of the first set of wheels while not driving a pair of passive wheels of the first set of wheels, the pair of passive wheels being provided in the cavity section; and
transferring a share of a load from the remotely operated vehicle to the rail system via the pair of passive wheels when moving the vehicle in that first horizontal direction, the pair of passive wheels being arranged on an opposite side of the center of gravity (COG) to the pair of driven wheels of the first set of wheels.

35. The method of claim 34, further comprising driving the pair of driven wheels of the first set of wheels using a drive motor provided in the motor section of the remotely operated vehicle.

36. The method of claim 35, further driving the pair of driven wheels by driving a wheel axle associated with the pair of the driven wheels of the first set of wheels in the motor section of the remotely operated vehicle.
